(19) United States
(12) Patent Application Publication
(10) Pub. No.: US 2018/0285148 A1
(43) Pub. Date: Oct. 4, 2018

(54) AUTOMATE CONTROL OF MEDIA PLAYBACK BASED ON VISIBILITY

(71) Applicant: Samuel Piers DUTTON, London (GB)

(72) Inventor: Samuel Piers DUTTON, London (GB)

(73) Assignee: Google Inc., Mountain View, CA (US)

(21) Appl. No.: 13/399,687

(22) Filed: Feb. 17, 2012

(51) Int. Cl. G06F 9/48; H04L 29/06

(52) U.S. Cl. CPC G06F 9/4843; H04L 29/06

(57) ABSTRACT

Disclosed herein are methods, systems, and non-transitory computer readable media for controlling playback of media. A method in accordance with an embodiment includes receiving, from one or more content scripts that are embedded on a webpage displayed on a browser, an indication of a media element present on the webpage, receiving from an API on the webpage, a value indicating whether the webpage is visible on the browser, and controlling playback of the media element based on the value.

### BACKGROUND

This specification relates to control of media playback on webpages.

The Internet provides access to a wide range of resources. For example, webpages for subjects are accessible over the Internet. These resources may be retrieved and viewed by users by typing in an identifier (e.g., a URL), or by clicking a link for the location of the resource. Resources may also include media resources such as video or audio files. The media elements can be played natively in the web browser, or through plugins.

Often times when multiple webpages are open, one or more of the webpages could be playing one of the media resources, some automatically without the user even initiating playback. It is difficult for a user to determine on which webpage media is being played. Further, bandwidth and other resources may be wasted for media that the user is unable to see or not paying attention to.

### BRIEF SUMMARY

Embodiments disclosed herein include methods, systems, and computer readable media for controlling playback of media elements on webpages. A method in accordance with an embodiment includes receiving, from one or more content scripts that are embedded on a webpage displayed on a browser, an indication of a media element present on the webpage, receiving from an API on the webpage, a value indicating whether the webpage is visible on the browser, and controlling playback of the media element based on the value.

A system, in accordance with an embodiment, may include one or more computers and one or more storage devices that store instructions. The instructions are operable, when executed by the one or more computers, to cause the one or more computers to perform operations including receiving, from one or more content scripts that are embedded on a webpage displayed on a browser, an indication of a media element present on the webpage, receiving from an API on the webpage, a value indicating whether the webpage is visible on the browser, and controlling playback of the media element based on the value.

Another aspect of the subject matter described herein is embodied in a non-transitory computer-readable medium storing software comprising instructions executable by one or more computers which, upon such execution, cause the one or more computers to per-form operations comprising receiving, from one or more content scripts that are embedded on a webpage displayed on a browser, an indication of a media element present on the webpage, receiving from an API on the webpage, a value indicating whether the webpage is visible on the browser, and controlling playback of the media element based on the value.

Further embodiments, features, and advantages of the invention, as well as the structure and operation of the various embodiments of the invention are described in detail below with reference to accompanying drawings.

### BRIEF DESCRIPTION OF THE DRAWINGS/FIGURES

Embodiments of the invention are described with reference to the accompanying drawings. In the drawings, like reference numbers may indicate identical or functionally similar elements. The drawing in which an element first appears is generally indicated by the left-most digit in the corresponding reference number.

FIG. 1 is an example of playback on a webpage.

FIG. 2 is a diagram of an example system.

FIG. 3 is a flow diagram of an example method.

FIG. 4 is a diagram of an example system.

### DETAILED DESCRIPTION

While the present invention is described herein with reference to the illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly de-scribed.

Webpages may include media such as video or audio that has been embedded into the webpage. For example, a webpage can include a music video. When a user a user opens webpages, the video may automatically start to play. When the user navigates to a different webpage, depending on whether or not the initial webpage is still visible on the browser, playback of the video can be paused.

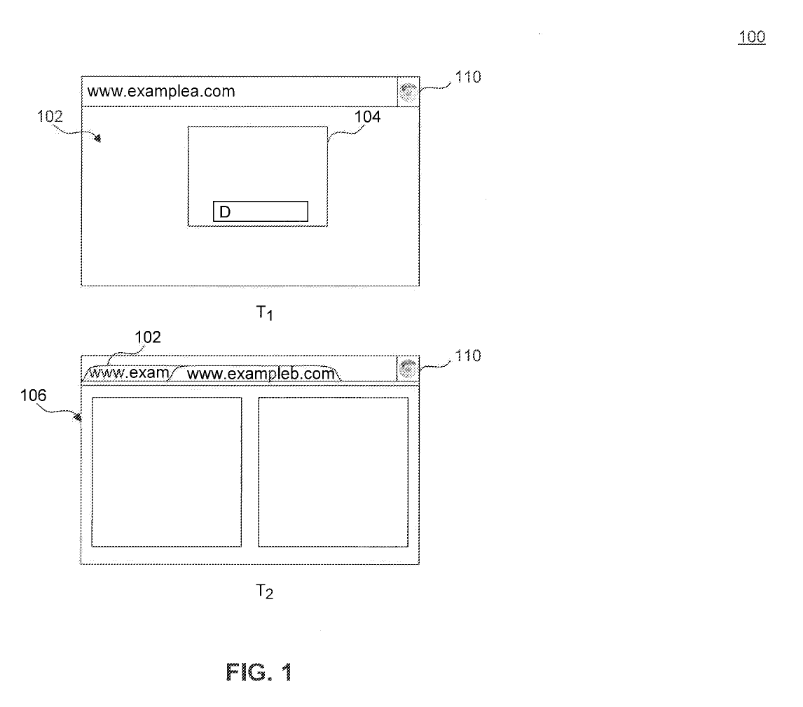

FIG. 1 is a diagram of an example scenario in accordance with an embodiment. FIG. 1 includes browser 100 shown at T1 with webpage 102 open. Webpage 102 includes video 104. When webpage 102 is loaded, video 104 automatically starts to play, if webpage 102 is visible on browser 100.

Browser 100 can include extension 110 that can control the playback of video 104 depending on whether webpage 102 is visible. Extension 110 can inject content scripts in webpage 102 when webpage 102 is loaded to detect medial elements on webpage 102. For example, extension 110 can detect video 104 on webpage 102.

When the user opens up an additional webpage 106 at time T2 in a new tab, and webpages 102 is no longer visible, since it is hidden by the tab displaying webpage 106, playback of the video 104 is paused by extension 110.

In one implementation, browser preferences can be changed to pause audio and/or pause video when the browser window is hidden. For example, a user can change the browser preferences and indicate whether to pause video when it is not in view or whether to not pause the video when it is not in view.

In another implementation, preferences can be set in the media element user interface, such as whether to pause playback if a webpage displaying the media element is hidden. For example, preferences can be set in a user interface of a video media element.

In another implementation, changes or additions to existing APIs can be made to implement this functionality. For example by adding a pauseIfHidden attribute to the HTMLMediaElement. The JavaScript API can be set to a “pauseIfHidden” value for the media element. The HTMLMediaElement could have additions to the interface, such as a pauseIfHidden attribute, that could be set (to true or false) by JavaScript.

In another implementations, there can be changes to player APIs such as BBC and EmP. Embedded media players such as the BBC Embedded Media Player or the Video Flash Player that are built using plugins (such as Flash, in this case, though other players might use Silverlight or other platforms) can include an API to set a pauseIfHidden flag. In the user interface, a Pause If Hidden option can be provided. In this way, embedded media using one of these platforms could be set by default to pause if hidden, but this value could be overridden by the user. For example, the value may be overridden because the users wants to listen to the audio from a presentation in one tab, while they browse in another tab.

In some implementations, playback is not paused when a user moves to a new page. For example, when listening to a radio station on the Internet in one tab while browsing in other tabs.

Extension 110 resumes playback of video 104 on webpage 102 when webpage 102 becomes visible again. For example, if the tab displaying webpage 102 is displayed again and the tab displaying webpage 106 is hidden.

Extension 110 can determine if webpage 102 is visible by receiving an event from an API on webpage 102 that notifies extension 110 when the visibility of webpage 102 changes. For example, this may be the Page Visibility API. Once webpage 102 is visible again, the API initiates an event, a visibility event, and extension 110 identifies this event. Extension 110 can then resume playback of video 102 once this event is initiated from the API. For example, the user can display webpage 102 again, and the tab displaying webpage 106 can be hidden behind the tab displaying webpage 102.

In one implementation, extension 110 pauses playback when any portion of webpage 102 is not visible. For example, if webpage 102 is displayed in a separate window from webpage 106, and the window displaying webpage 106 partially covers the window displaying webpage 102, extension 110 will pause playback of video 104.

In another implementation, extension 110 pauses playback when all of webpage 102 is not visible. For example, if webpage 102 is displayed in a separate window from webpage 106, and the window displaying webpage 106 partially covers the window displaying webpage 102, extension 110 will not pause playback of video 104. Extension 110 only pauses playback when all of webpage 102 is not visible.

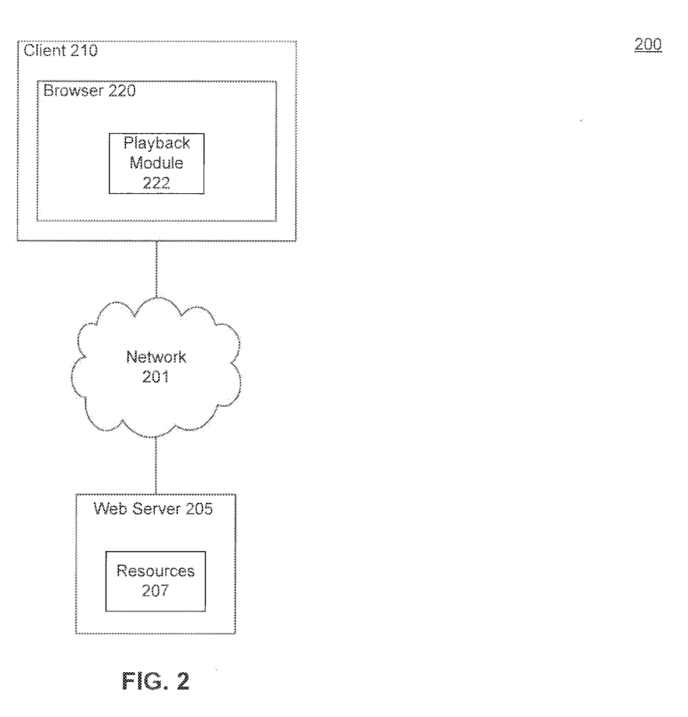

FIG. 2 is a diagram of a system 200 in accordance with an embodiment. System 200 includes client 210. Client 210 may be a desktop computer, laptop computer, mobile device, smartphone, tablet device, or any other computing device. Client 210 may execute applications including browser 220. Browser 220 includes playback module 222, which may receive from content scripts on a webpage an indication of media elements and also receive from an API on the webpage, a value indicating whether the webpage is visible on the browser. In one implementation, playback module 222 is an extension that can be installed on any browser 220. In another implementation, playback module 222 is part of browser 220.

System 200 also includes web server 205, which may provide access to one or more resources 207. A resource 207 is any data that can be provided over a network, and may include, for example and without limitation, one or more webpages, HTML documents, multimedia content, images, or other resources. A resource 207 is identified by a resource address that is associated with the resource 207. Resources include HTML pages, web-based applications, word processing documents, and portable document format (PDF) documents, images, video, and feed sources, to name only a few. The resources can include content, such as words, phrases, images and sounds, that may include embedded information (such as meta-information in hyperlinks) and/or embedded instructions (such as JavaScript scripts).

A client 210 can request resources 207 from a web server 205. In turn, data representing the resource 207 can be provided to the client 210 for presentation by the client 210. Client 210 may access web server 205 using network 201, which may be a local area network or wide area network such as the Internet. The links between client 210 and network 201, and between network 201 and web server 205 may be wired links or wireless links.

In accordance with an embodiment, browser 220 of client 210 may retrieve a resource 207, such as a user-desired web-based application, from a web server 205 over network 201. If resource 207 includes a media element, and playback module 222 determines that a value received from an API embedded in the resource 207, a webpage, indicates that the webpage is visible, then the playback module 222 can either allow the media element to continue playing if it was already playing, or if paused, can resume playback of the video from the pause position.

In one implementation, a JavaScript API called the Page Visibility API may initiate an event when a webpage is not visible, and when the webpage is visible. Playback module 222 can receive the event and pause or resume playback of media elements based on the event received.

In one implementation playback module 222 can make a list of all of the media elements on a webpage. Once it has that list of media elements, playback module 222 uses the value from the page visibility API to determine if a webpage is visible or not visible. If the webpage is visible, playback of the media element is resumed. If visibility changes and the webpage is not visible, playback module 222 can pause playback of the media element. If the webpage is not visible, playback is paused. If visibility changes, playback module 222 can resume playback of the media element.

In one implementation, when a window with a media element on it is minimized, playback of the video is paused until the window is maximized again. In another implementation, when a webpage includes a media element and then a new tab is opened in the browser, hiding the previous webpage with the media element, the media element is paused.

In another implementation, if a webpage includes a media element and the webpage is scrolled to where a portion of the media element is not displayed on the webpage, but rather hidden from view, then playback of the media element is paused by playback module 222. A plugin can be installed, such as the j Query inview, that can check for partial visibility. The value received from the plugin, such as the j Query inview can be used by the playback module 222 to control playback. For example, the entire video is visible again, playback of the video can be resumed. In another implementation, if the video is partially visible, playback is not paused. It is only when a user scrolls the webpage to where the video is no longer visible on the browser that playback module 222 pauses the video.

In one implementation, when a webpage is first opened, if the webpage is not visible, or if the media element is set on auto play, it does not auto play if the page is not visible.

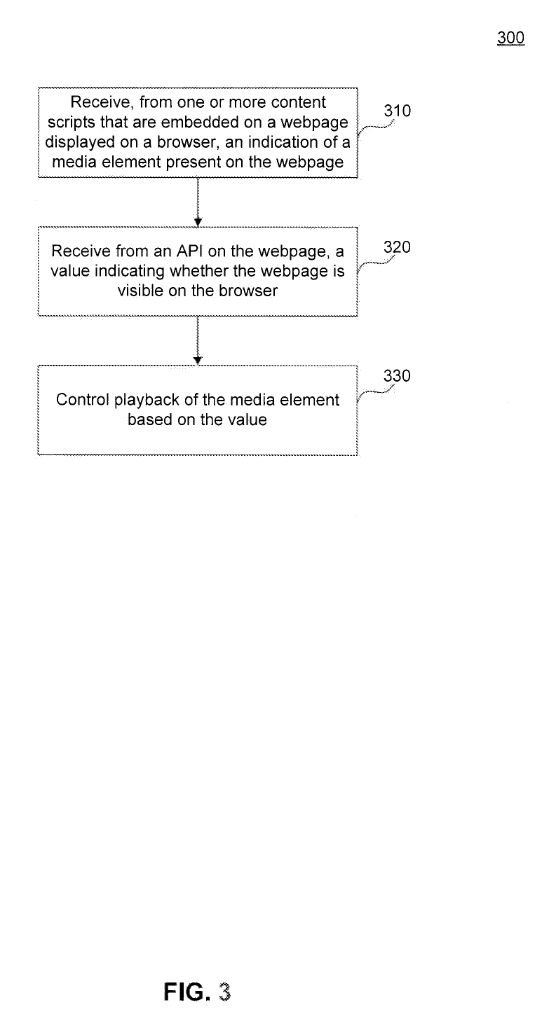

FIG. 3 is a flow chart of a method 300 for displaying web-based applications as a group, in accordance with an embodiment. Method 300 may be implemented, for example and without limitation, by a web browser 220 executing on a computing device or client 210.

At stage 310, an indication is received from one or more content scripts that are embedded on a webpage displayed on a browser. The indication received indicates whether or not a media element is present on the webpage. The content scripts can be provided to be embedded on a webpage or into a browser. The content scripts detect the media elements. For example, the content scripts may identify a video on the webpages the send an indication of the webpage of the video being present on the webpage.

At stage 320, a value indicating whether the webpage is visible on the browser is received from an API on the webpage. The browser can have open many tabs with a number of different webpages. Therefore, only one tab can be visible on the browser, which is the active tab. In another implementation, more than one tab can be visible on the browser. For example, a tab can be open on the top of a browser and a tab can be open on the bottom of a browser.

In another implementation, a browser can have multiple browser windows open with different webpages. One or more of them can be visible depending on the screen size of the client device. One or more of them can be resized so that multiple webpages can be visible in different windows.

The page visibility API can determine which of the one or more tabs, or one or more browser windows is visible on the browser. A value indicating that the webpage is not visible on the browser can be received from the API, for example by the browser displaying the webpage on which the media element is displayed.

At stage 330, playback of the media element is controlled based on the value. If the value indicates that the browser is not visible, then playback of the media item is stopped or paused. If the value indicates that the browser is visible, then the media item is played.

In one implementation, if a portion of the media item is visible on the browser, and a portion hidden from view, then playback is still initiated for the media item. For example, a user may be viewing a webpage with a video embedded on the webpage, and the user may scroll down on the webpage so that half of the media item is hidden from view and half is visible. In this situation, the playback of the media item would continue.

In another implementation if a portion of the media item is visible on the browser, and a portion hidden from view, then playback is stopped for the media item. For example, in the same scenario above, if the user scrolls the page down, as soon as a part of the video is not displayed on the browser anymore, playback of the video is stopped.

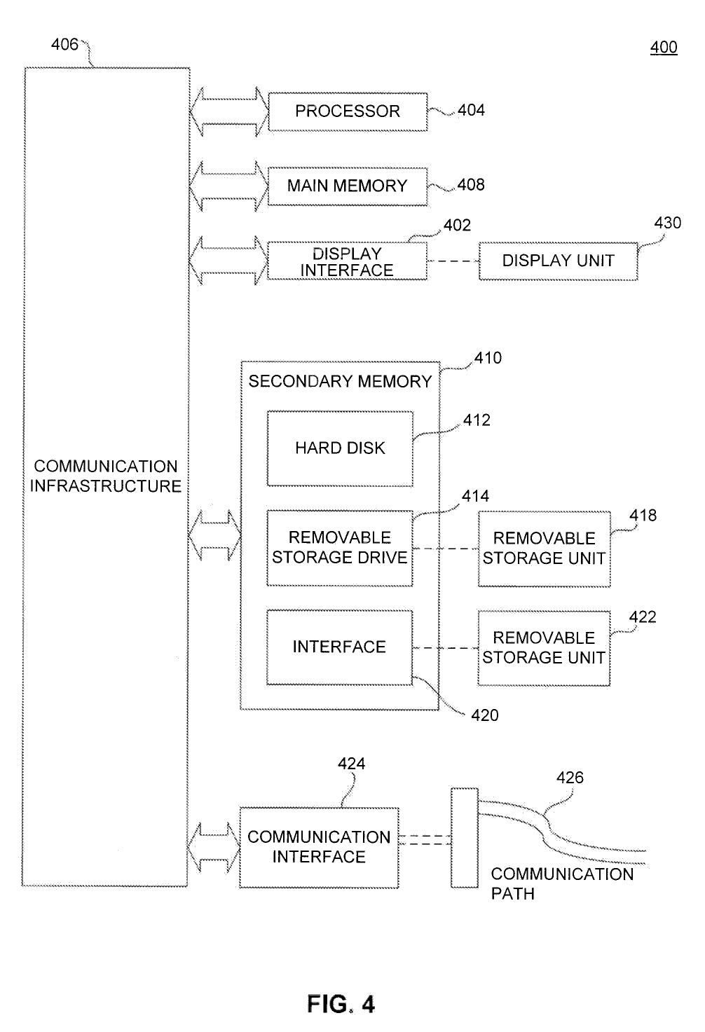

Various aspects of the present invention can be implemented by software, firmware, hardware, or a combination thereof. FIG. 4 illustrates an example computer system 400 in which the embodiments, or portions thereof, can be implemented as computer-readable code. For example, browser 220 carrying out method 300 of FIG. 3 can be implemented in system 400. Various embodiments of the invention are described in terms of this example computer system 400.

Computer system 400 includes one or more processors, such as processor 404. Processor can be a special purpose or a general purpose processor. Processor 404 is connected to a communication infrastructure 406 (for example, a bus or network).

Computer system 400 also includes a main memory 408, preferably random access memory (RAM), and may also include a secondary memory 410. Secondary memory 410 may include, for example, a hard disk drive and/or a removable storage drive. Removable storage drive 414 may include a floppy disk drive, a magnetic tape drive, an optical disk drive, a flash memory, or the like. The removable storage drive 414 reads from and/or writes to removable storage unit 418 in a well-known manner. Removable storage unit 418 may include a floppy disk, magnetic tape, optical disk, etc. which is read by and written to by removable storage drive 414. As will be appreciated by persons skilled in the relevant art(s), removable storage unit 418 includes a computer usable storage medium having stored therein computer software and/or data.

In alternative implementations, secondary memory 410 may include other similar means for allowing computer programs or other instructions to be loaded into computer system 400. Such means may include, for example, a removable storage unit 422 and an interface 420. Examples of such means may include a program cartridge and cartridge interface (such as that found in video game devices), a removable memory chip (such as an EPROM, or PROM) and associated socket, and other removable storage units 422 and interfaces 420 which allow software and data to be transferred from the removable storage unit 422 to computer system 400.

Computer system 400 may also include a communications interface 424. Communications interface 424 allows software and data to be transferred between computer system 400 and external devices. Communications interface 424 may include a modem, a network interface (such as an Ethernet card), a communications port, a PCMCIA slot and card, or the like. Software and data transferred via communications interface 424 are in the form of signals, which may be electronic, electromagnetic, optical, or other signals capable of being received by communications interface 424. These signals are provided to communications interface 424 via a communications path 426. Communications path 426 carries signals and may be implemented using wire or cable, fiber optics, a phone line, a cellular phone link, an RF link or other communications channels.

In this document, the term “computer readable storage medium” is used to generally refer to media such as removable storage unit 418, removable storage unit 422, and a hard disk installed in hard disk drive 412. Computer readable storage medium can also refer to one or more memories, such as main memory 408 and secondary memory 410, which can be memory semiconductors (e.g. DRAMs, etc.). These computer program products are means for providing software to computer system 400.

Computer programs (also called computer control logic) are stored in main memory 408 and/or secondary memory 410. Computer programs may also be received via communications interface 424. Such computer programs, when executed, enable computer system 400 to implement the embodiments as discussed herein. In particular, the computer programs, when executed, enable processor 404 to implement the processes of embodiments of the present invention, such as the steps in the methods discussed above. Accordingly, such computer programs represent controllers of the computer system 400. Where embodiments are implemented using software, the software may be stored in a computer program product and loaded into computer system 400 using removable storage drive 414, interface 420, or hard drive 412.

Embodiments of the invention also may be directed to computer program products comprising software stored on any computer-readable medium. Such software, when executed in one or more data processing device, causes a data processing device(s) to operate as de-scribed herein. Embodiments of the invention employ any computer useable or readable medium. Examples of tangible computer-readable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

Embodiments may be implemented in hardware, software, firmware, or a combination thereof. Embodiments may be implemented via a set of programs running in parallel on multiple machines.

The summary and abstract sections may set forth one or more but not all exemplary embodiments of the present invention as contemplated by the inventor(s), and thus, are not intended to limit the present invention and the appended claims in any way.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A computer-implemented method, comprising:
receiving, from one or more content scripts that are embedded on a first webpage of a browser, an indication of at least one of an audio or video media element present on the first webpage;
automatically playing the media element when at least a portion of the first webpage of the browser comprising the media element is visible;
determining whether a second webpage of the browser is displayed and overlaps the media element on the first webpage;
determining whether an attribute of the media element on the first webpage is set to continue playing the media element when the second webpage overlaps the first webpage;
when the second webpage is determined to overlap the media element on the first webpage and the attribute is not set to continue playing the media element, then stopping or pausing the playing of the media element;
when the second webpage overlaps the media element on the first webpage and the attribute is set to continue playing the media element when the second webpage overlaps the first webpage, then continuing the playing of the media element; and
receiving user input indicating whether to stop or pause playing of the media element when the media element is not visible, wherein the user input overrides the attribute of the media element on the first webpage when the attribute of the media element is set to continue playing the media element when the media element is not visible.

2. The method of claim 1, further comprising receiving from an application programming interface (API) on the first webpage, a value indicating whether the first webpage of the browser is visible.

3. (canceled)

4. The method of claim 2, wherein the value indicates that the first webpage of the browser is visible.

5. (canceled)

6. (canceled)

7. The method of claim 1, further comprising:
providing the one or more content scripts to be embedded into the first webpage.

8. The method of claim 1, wherein the one or more content scripts detect the media element.

9. A system comprising:
a computer and a storage device storing instructions that are operable, when executed by the computer, to cause the computer to perform operations comprising:
automatically playing a media element on a first webpage of a browser when the first webpage is visible and a second webpage is not overlapping the media element on the first webpage;
determining whether an attribute on the first webpage has been set to continue playing the media element when the second webpage is displayed and covers the media element on the first webpage;
when the second webpage is determined to cover the media element on the first webpage and the attribute has been set to not continue playing the media element, then stopping or pausing the playing of the media element, otherwise continuing the playing of the media element; and
receiving user input indicating whether to stop or pause playing of the media element when the media element is not visible, wherein the user input overrides the attribute of the media element on the first webpage.

10. The system of claim 9, wherein the operations further comprise receiving from an application programming interface (API) on the first webpage, a value indicating whether the first webpage of the browser is visible.

11. (canceled)

12. The system of claim 10, wherein the value indicates that the first webpage of the browser is visible.

13. (canceled)

14. (canceled)

15. The system of claim 9, wherein the operations further comprise:
providing a content script to be embedded into the first webpage; and
receiving, from the content script embedded on the first webpage, an indication of the media element being present on the first webpage.

16. The system of claim 15, wherein the content script detects the media element on the first webpage.

17. A non-transitory computer-readable medium storing software comprising instructions executable by a computer which, upon such execution, cause the computer to perform operations comprising:
automatically playing a media element on a first webpage of a browser when the first webpage is displayed without any portion being covered by a second webpage of the browser;
determining whether the second webpage is displayed and covering the media element on the first webpage;
when the second webpage is determined to cover the media element on the first webpage, then stopping or pausing the playing of the media element when an attribute of the media element on the first webpage is set to stop or pause playing of the media element when the media element is not visible; and
receiving user input indicating whether to stop or pause playing of the media element when the media element is not visible, wherein the user input overrides the attribute of the media element on the first webpage.

18. The non-transitory computer-readable medium of claim 17, wherein the operations further comprise:
receiving from an application programming interface (API) on the first webpage, a value indicating whether the first webpage of the browser is visible.

19. The non-transitory computer-readable medium of claim 18, further comprising:
controlling playback of the media element based on the value, wherein controlling playback of the media element based on the value comprises: pausing playback of the media element.

20. The method according to claim 1, further comprising:
continuing to play the media element when no portion of the media element is covered by the second webpage.

21. The system of claim 9, wherein the attribute comprises a hypertext markup language (HTML) attribute.

22. The non-transitory computer-readable medium of claim 17, wherein the attribute comprises a hypertext markup language (HTML) attribute.

23. The non-transitory computer-readable medium of claim 17, further comprising:
automatically playing the media element on the first webpage when the first webpage is displayed without any portion being covered by the second webpage and the media element being visible on the first webpage.

24. (canceled)

25. The method of claim 1, wherein the attribute comprises a hypertext markup language (HTML) attribute.

26. The system of claim 9, wherein the first webpage is displayed in a first tab of the browser and the second webpage is displayed in a second tab of the browser.
